(19) United States
(12) Patent Application Publication
(10) Pub. No.: US 2005/0002557 A1
(43) Pub. Date: Jan. 6, 2005

(54) Method for designing a template that removably fits to an objects surface

(76) Inventors: Steven Lobregt, Eindhoven (NL); Jozef Johannes Schillings, Eindhoven (NL); Edward Vuurberg, Eindhoven (NL)

Correspondence Address: Philips Electronics North America Corporation;Corporate Patent Counsel, PO Box 3001, Briarcliff Manor, NY, 10510, US

(21) Appl. No.: 10/492,448

(22) PCT Filed: Oct. 11, 2002
(86) PCT No.: PCT/IB02/04204

(30) Foreign Application Priority Data
Oct. 16, 2001 (EP) 01203940.0

(51) Int. Cl. G06K 9/00

(52) U.S. Cl. 382/154

(57) ABSTRACT

The invention relates to a method for designing a template that removably fits to an object's surface, comprising the steps of: obtaining in a computer aided design system a digitized three-dimensional image of the object determining an approach direction for the template to be placed on the object manipulating the image for removal of undercuts related to the approach direction resulting in a modified image of the object defining the template depending on the shape of the modified image, in which the image is processed for visualization in a viewing direction that identifies with the approach direction, and that the so processed image is used as the modified image depending on which the template is designed.

The invention relates to a method for designing a template that removably fits to an object's surface, comprising the steps of:
obtaining in a computer aided design system a digitized image of the object
determining an approach direction for the template to be placed on the object
manipulating the image for removal of undercuts related to the approach direction resulting in a modified image of the object
defining the template depending on the shape of the modified image.

Such a method is used for designing parts which have to fit closely to the surface of an object. The method is known from practice.

The design of the part which is to fit to the object's surface should basically follow the outer contour of the object onto which the part is to be fitted. The problem that associates however to this basic requirement is that the outer shape of the object's surface is not at all times suited to allow the placement and the subsequent removal of the concerning part. In order to be able to place such part on a given object and remove it therefrom afterwards, it is sometimes necessary to avoid a precise matching of the template from which the part will be manufactured, depending on the approach direction.

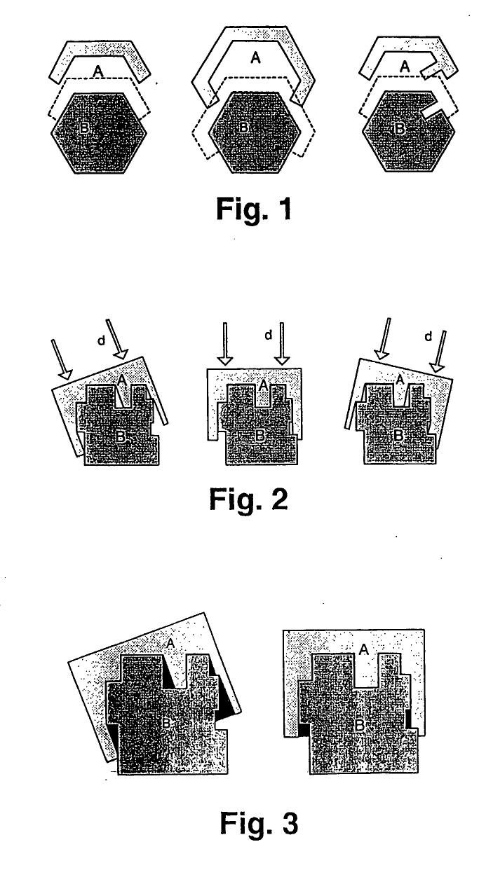

The problem is illustrated with reference to FIG. 1, showing respectively on the left a template A, which allows for placing on and subsequent removal from a surface of an object B. In the middle and in the right of the FIG. 1, two examples are shown in which a template A, that perfectly matches the outer curvature of the object B, is not capable to be placed and subsequently removed from the object B.

FIG. 2 shows the same problem illustrated with reference to a varying approach direction d of the template A with respect to the object B. Depending on the approach direction that has been elected it is required to avoid a precise matching of the outer curvature of the object B in the template A, in order to be able to place on, and subsequently remove template A from object B.

FIG. 3 shows in black areas the parts that should not form part of the template A, in order to allow the placement and subsequent removal of the template A from the object B. Said black parts are known in the art as undercuts.

In determining the desired shape of the template A, the prior art takes care of removal of said undercuts in a process such as sweeping or extrusion of the surface of object B in the approach direction. The calculation that is required for this process is difficult and computationally expensive. The invention is aimed at simplifying this method and to make it computationally less expensive.

To this end the method of the invention for designing a template that removably fits to an object's surface is characterized in that the image of the object is processed for visualization in a viewing direction that coincides with the approach direction, and that the so processed image is used as the modified image depending on which the template is designed.

The image of the object may have the form of a multidimensional data set e.g. two-dimensional or three-dimensional data set. Such a multidimensional data set assigns data values to respective positions in the multi (e.g. 2 or 3) dimensional geometric space. The multidimensional data set in particular represents the spatial shape of the object.

The invention is the based on the recognition that between the approach direction in undercut removal directly corresponds to the visual subject matter that comes visible when looking at three-dimensional structures in a predetermined viewing direction. The parts that are invisible in the three-dimensional visualization are exactly the undercuts that must be removed from the template when it is to fit the visualized object.

An efficient and computationally relatively easy way of removing the undercuts is embodied in a method, which is characterized in that the image is processed for visualization by determining for each ray in a set of imaginary rays parallel to the viewing direction, the distance from a common line of departure of said rays to the surface of the image of the object, and that the distances for each of said rays are collected for building the modified image of the object. A modified image of the object which is built this way is devoid of the undercuts that have to be avoided, and which by their very nature cannot be seen when looked at the object in the viewing direction. The template manufactured such that it matches the outer surface of the modified image of the object, is capable of being placed on, and subsequently removed from the original object. The set of distances collected in the above-described manner pertaining to the image of the object, is referred to in the art as the so-called Z-buffer or Depth Buffer.

The method as just described is particularly useful when the template is a drill guide to be placed on a patient's mandible or maxilla as a surgeon's tool for determining parameters of holes for dental implants.

Beneficially the surface of the mandible or maxilla to which the drill guide is to be placed, is defined in a process of interactively positioning graphical representations of dental implants in a three-dimensional image of said mandible or maxilla.

Preferably the approach direction of the drill guide is determined in dependency of characteristics of the three-dimensional image of said mandible or maxilla.

The invention also relates to a workstation and to a computer program. The workstation according to the invention is defined in claim 7. The workstation according to the invention is able to carry-out the method of the invention. The computer program according to the invention is defined in claim 6. When loaded into a computer, the computer program enables the computer to bring about technical effects associated with the method of the invention. The computer program according to the invention can be provided on a data carrier such as a CD-ROM, or the computer program may be made available via a data network such as the world-wide web.

The invention will hereafter further be elucidated with reference to the drawing in which:

FIGS. 1, 2 and 3 illustrate the problem of designing a template of an object's surface, that allows for placement and subsequent removal, and

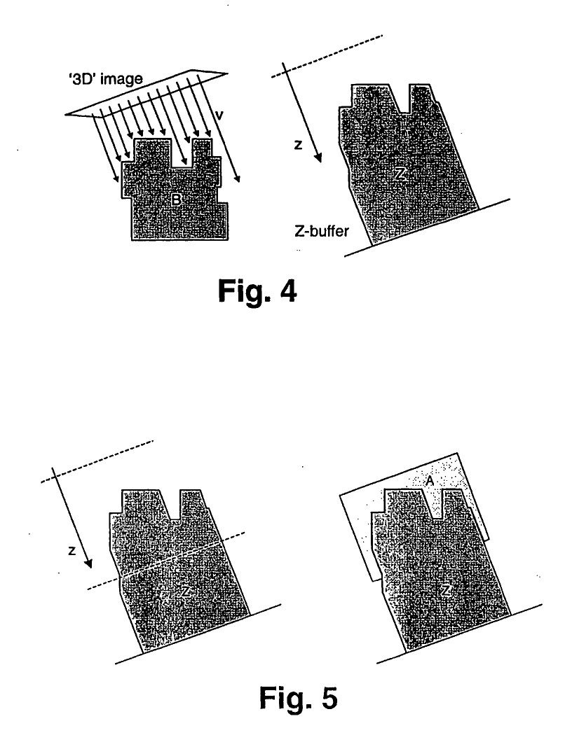

FIGS. 4 and 5 illustrate the method according to the invention.

The problem that the invention seeks to solve is elucidated above with reference to FIGS. 1 to 3.

With reference first to FIG. 4 the following discussion of the invention is offered.

Starting with a digitized three-dimensional image of the object B in a computer aided design system, the method of the invention processes this image that is shown on the left-hand side in FIG. 4, and converts it into the modified image shown on the right-hand side in FIG. 4. As mentioned above the basis of the method according to the invention is the recognition of the similarity between the approach direction in undercut removal and the viewing direction in the visualization of three-dimensional structures.

Surface parts which need not be modified for undercut removal given a particular approach direction are exactly those parts of the surface which are visible after visualization of the three-dimensional object B using parallel projection along that same approach direction.

The parts, which are invisible in this three- dimensional visualization, are the surface parts that must be modified, and more precisely: which have to be extruded in the viewing/approach direction.

For the visualization of three-dimensional structures one can advantageously make use of an intermediate structure called the Z-buffer or Depth Buffer. This structure is actually an image with the same size of the resulting projection image, which holds the distance z along the projection rays from viewing position to the point where each ray hits the surface of the visualized object B. As such, the Z-buffer can be interpreted itself as a surface in three-dimensions; a two-dimensional image with x, y co-ordinates and a pixel value z as a third dimension. The volume z (see right-hand side of FIG. 4) enclosed by the Z-buffer surface and some arbitrary (large enough) value of z can be regarded as an object with the same shape as the above mentioned object B as shown on the left-hand side of FIG. 4.

The Z-buffer is, as mentioned before, automatically generated when a visualization of the object B is calculated. This is the case regardless of whether the shape of object B is represented as a discrete binary voxel volume or by means of a geometric surface description. The Z-buffer can be described geometrically like a triangulation mesh for instance. The desired shape of template A can be determined from there by taking the negative of the shape of the volume Z, which is enclosed by the Z-buffer surface. See FIG. 5, right-hand side.

The beauty of the invention is that it transports visualization methods that have evolved to the point that they are quite fast, to the subject field of designing templates that have to fit to (complicated) surfaces of objects. Sub-second reconstruction times are common, meaning that modification of the visualization direction, including the generation of a matching Z-buffer, can be done interactively with visual feedback of the three-dimensional image of the object B.

The three-dimensional image could be combined with additional graphics representing relevant information to help the user find the optimal approach direction. In some situations the required approach direction may already be known, or may be automatically derived from other information, in which case the interactive determination of approach with visual feedback can be skipped.

The proposed procedure becomes as follows:
Interactive visualization of object B and determination of optimal approach direction d
Calculate geometric description (e.g. triangulation) of the Z-buffer surface
Determination of the shape of fitting template A as a negative of the shape of the volume z

With this proposed procedure there is no need anymore to manipulate the shape of a geometrically described surface, which is difficult and a costly part of procedures of the prior art. By means of three-dimensional drawing tools and visual feedback of the three-dimensional image of object B, it is also possible to interactively indicate the part of the surface of object B which needs to be in contact with template A. This enables another important optimization, as then only the relevant part of the Z-buffer surface needs to be triangulated or otherwise described.

The method of the invention can effectively be used in the design of a drill guide, which is to be placed on a patient's gums, teeth, mandible or maxilla as a surgeon's tool for determining parameters of holes for dental implants. The proposed steps in such an application can than be the following:
Determine position, orientation, length and diameter of holes, which need to be drilled in gums, teeth, mandible or maxilla of the patient for placement of dental implants.
This is done pre-operatively, using three-dimensional visualizations of the bone in combination with two-dimensional cross-sections showing structure, density, etc. of the bone and surrounding soft tissue. These visualizations are for instance derived from a previously acquired three-dimensional CT scan of the relevant patient volume. Graphical representations of dental implants can be positioned and manipulated interactively, all the time visualized as three-dimensional objects and two-dimensional cross-sections together with the patient information.
Indicate which part of the gums, teeth, or bone surface will serve as a contact area for the drill guide.
Determine the approach direction visually by manipulating the three-dimensional view of the patient's anatomy.
Triangulate the relevant part of the Z-buffer surface.
Use this surface patch as a basis for automatic design of the complete drill guide with cylindrical holes at the proper locations, with proper diameter, etc. which enable the surgeon to drill exactly according the planning.
Export the surface description of the drill guide to a manufacturer, who produces the drill guide and sends it back.
Place the drill guide in contact with the patients' gums, teeth or bone during operation, and drill at the planned position, depth, diameter, etc. by placing the drill in the holes provided by the drill guide.

As will be clear from the above description the invention is applicable to many areas of technology in which an object must be designed to match and yet be able to be placed against another object and subsequently be removed. The invention is therefore considered not to be limited to the above elucidation but be restricted to the appended claims only wherein the above elucidation only serves to remove any unclarities.

1. Method for designing a template that removably fits to an object's surface, comprising the steps of:
obtaining in a computer aided design system a digitized image of the object
determining an approach direction for the template to be placed on the object
manipulating the image for removal of undercuts related to the approach direction resulting in a modified image of the object
defining the template depending on the shape of the modified image,
characterized in that the image is processed for visualization in a viewing direction that coincides with the approach direction, and that the so processed image is used as the modified image depending on which the template is designed.

2. Method according to claim 1, characterized in that the image is processed for visualization by determining for each ray in a set of imaginary rays parallel to the viewing direction, the distance from a common line of departure of said rays to the surface of the image of the object, and that the distances for each of said rays are collected for building the modified image of the object.

3. Method according to claim 1, characterized in that the template is a drill guide to be placed on a patient's gums, teeth, mandible or maxilla as a surgeon's tool for determining parameters of holes for dental implants.

4. Method according to claim 3, characterized in that the surface of the gums, teeth, mandible or maxilla to which the drill guide is to be placed, is defined in a process of interactively positioning graphical representations of dental implants in a three-dimensional image of said gums, teeth, mandible or maxilla.

5. Method according to claim 3, characterized in that the approach direction of the drill guide is determined in dependency of characteristics of the three-dimensional image of said gums, teeth, mandible or maxilla.

6. A computer program comprising instructions for
obtaining a digitized image of the object
determining an approach direction for the template to be placed on the object
manipulating the image for removal of undercuts related to the approach direction resulting in a modified image of the object
defining the template depending on the shape of the modified image,
characterized in that
the image is processed for visualization in a viewing direction that identifies with the approach direction, and that the so processed image is used as the modified image depending on which the template is designed.

7. A workstation arranged to
obtaining a digitized image of the object
determining an approach direction for the template to be placed on the object
manipulating the image for removal of undercuts related to the approach direction resulting in a modified image of the object
defining the template depending on the shape of the modified image,
characterized in that
the image is processed for visualization in a viewing direction that identifies with the approach direction, and that the so processed image is used as the modified image depending on which the template is designed.
